(19) United States
(12) Patent Application Publication
(10) Pub. No.: US 2022/0083444 A1
(43) Pub. Date: Mar. 17, 2022

(54) PERFORMANCE ANALYSIS METHOD AND COMPUTER-READABLE RECORDING MEDIUM STORING PERFORMANCE ANALYSIS PROGRAM

(71) Applicant: FUJITSU LIMITED, Kawasaki-shi (JP)

(72) Inventor: MASAO YAMAMOTO, Kawasaki (JP)

(73) Assignee: FUJITSU LIMITED, Kawasaki-shi (JP)

(21) Appl. No.: 17/369,619

(22) Filed: Jul. 7, 2021

(30) Foreign Application Priority Data
Sep. 17, 2020 (JP) 2020-156064

(51) Int. Cl. G06F 11/34; G06F 9/455

(52) U.S. Cl. CPC G06F 11/3419; G06F 2009/45591; G06F 9/45558; G06F 11/3495

(57) ABSTRACT

A performance analysis method causes a computer to execute a process including grouping a plurality of containers into a plurality of groups based on respective generation time points of the plurality of containers; executing performance analysis on the plurality of containers for each of the plurality of groups; and outputting a result of the performance analysis for each of the plurality of groups.

### CROSS-REFERENCE TO RELATED APPLICATION

This application is based upon and claims the benefit of priority of the prior Japanese Patent Application No. 2020-156064, filed on Sep. 17, 2020, the entire contents of which are incorporated herein by reference.

### FIELD

The embodiments discussed herein are related to a performance analysis method and a computer-readable recording medium storing performance analysis program.

### BACKGROUND

In recent years, there have been provided, for example, cloud services for lending virtual machines (VMs) generated in physical machines.

Japanese Laid-open Patent Publication No. 2002-082926 is disclosed as related art.

### SUMMARY

According to an aspect of the embodiments, a performance analysis method causes a computer to execute a process including grouping a plurality of containers into a plurality of groups based on respective generation time points of the plurality of containers; executing performance analysis on the plurality of containers for each of the plurality of groups; and outputting a result of the performance analysis for each of the plurality of groups.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a configuration of an information processing system;

FIG. 2 is a diagram for explaining a hardware configuration of a management apparatus;

FIG. 3 is a block diagram of functions of the management apparatus;

FIG. 4 is a flowchart for explaining an outline of performance analysis processing in a first embodiment;

FIG. 5 is a diagram for explaining the outline of the performance analysis processing in the first embodiment;

FIG. 6 is a flowchart for explaining details of the performance analysis processing in the first embodiment;

FIG. 7 is a flowchart for explaining the details of the performance analysis processing in the first embodiment;

FIG. 8 is the flowchart for explaining the details of the performance analysis processing in the first embodiment;

FIG. 9 is a flowchart for explaining the details of the performance analysis processing in the first embodiment;

FIG. 10 is the flowchart for explaining the details of the performance analysis processing in the first embodiment;

FIG. 11 is a diagram for explaining a specific example of operation information;

FIG. 12 is a diagram for explaining a specific example of process generation information;

FIG. 13 is a diagram for explaining a specific example of process association information;

FIG. 14 is a diagram for explaining a specific example of Pod information;

FIG. 15 is a diagram for explaining a specific example of the operation information;

FIG. 16 is a diagram for explaining a specific example of the operation information;

FIG. 17 is a diagram for explaining a specific example of result information;

FIG. 18 is a diagram for explaining a specific example of the operation information;

FIG. 19 is a diagram for explaining a specific example of the operation information;

FIG. 20 is a diagram for explaining a specific example of the operation information; and

FIG. 21 is a diagram for explaining a specific example of the result information.

### DESCRIPTION OF EMBODIMENTS

For example, a business operator who provides a cloud service (hereinafter, also simply referred to as a cloud operator) lends a VM to a user who constructs an information processing system (hereinafter, also simply referred to as a cloud user). Using the information processing system constructed on the VM borrowed from the cloud operator, the cloud user provides various services to users who use the services (hereinafter, also referred to as service users).

In this case, for the purpose of quickly providing the services, for example, the cloud user generates containers in the information processing system and operates application programs for providing the services in the generated containers. The cloud user implements each of the various services by using a combination of one or more containers (hereinafter, such a combination will be also referred to as a Pod) and provides the services to the service users.

In the cloud service as described above, multiple information processing systems constructed by multiple cloud users may operate on the same physical machine. For this reason, for example, performance degradation in a service provided by a certain cloud user may be caused by the underlying physical machine or an information processing system constructed by another cloud operator.

Therefore, when an abnormality such as degradation in service performance occurs, the cloud operator takes countermeasures such as finding out the abnormal location by performing an overall investigation of the entire physical machine on which the multiple information processing systems operate. In this case, for example, the cloud operator takes the countermeasures such as detecting the abnormality occurring in the containers by executing performance analysis that visualizes the running times of respective functions included in programs being executed by the containers (performance profiling) based on pieces of operation information of the respective functions (hereinafter, also simply referred to as the piece of operation information).

However, each piece of operation information for a container does not include information that enables a service associated with the piece of operation information to be identified. For this reason, the cloud operator may be unable to classify the pieces of operation information in the containers acquired from the physical machine into information sets associated with the respective services, and therefore have no way to the performance analysis for each service. Therefore, for example, the cloud operator may be unable to identify a process that consumes a long time for execution on a service-by-service basis and fail to find out a location which causes a problem in each of the services.

Accordingly, in one aspect, a performance analysis method and a performance analysis program that enable execution of performance analysis on a service-by-service basis may be provided.

[Configuration of Information Processing System]

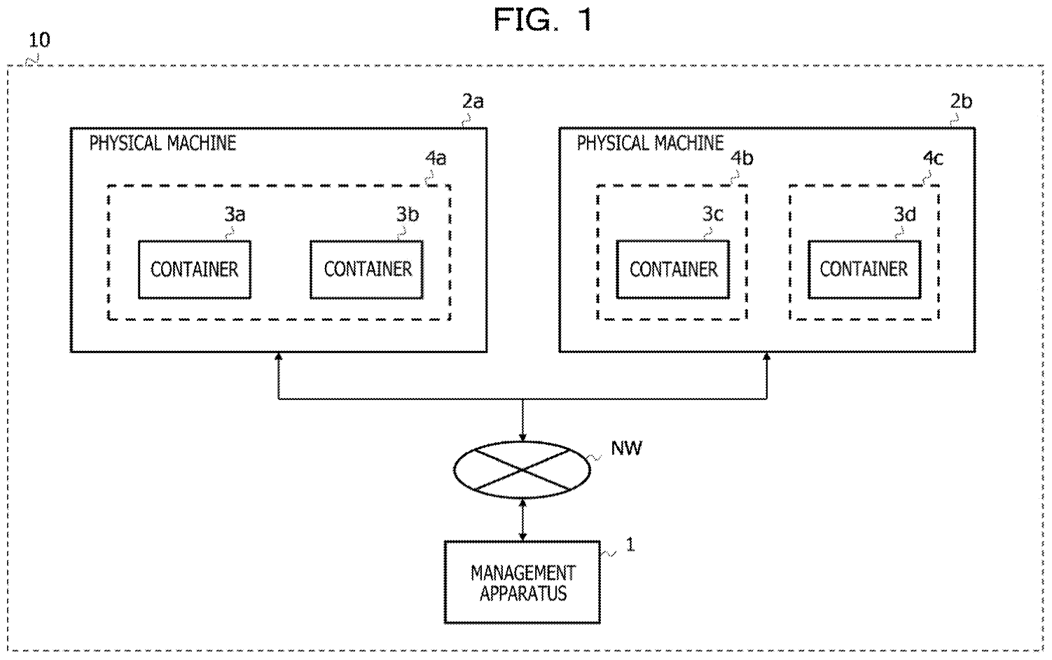

First, a configuration of an information processing system 10 will be described. FIG. 1 is a diagram for explaining the configuration of the information processing system 10.

The information processing system 10 illustrated in FIG. 1 includes a management apparatus 1 and physical machines 2a and 2b. Containers 3a and 3b operate on the physical machine 2a, and containers 3c and 3d operate on the physical machine 2b.

In the example illustrated in FIG. 1, a container group including the container 3a and the container 3b (hereinafter, the container group will be also referred to as a Pod 4a) provides a single service to service users. Similarly, a container group including the container 3c (hereinafter, also referred to as a Pod 4b) and a container group including the container 3d (hereinafter, also referred to as a Pod 4c) provide different services to the service users.

The physical machines 2a and 2b will be collectively referred to as the physical machines 2, the containers 3a, 3b, 3c and 3d will be collectively referred to as the containers 3, and the Pods 4a, 4b, and 4c will be collectively referred to as the Pods 4, below. Although the case where the information processing system 10 includes the two physical machines 2 will be described below, the information processing system 10 may include any number of physical machines 2 other than two. Although the case where the physical machines 2 operate the containers 3a, 3b, 3c, and 3d will be described below, the physical machines 2 may operate any number of containers other than four.

As for a unit for lending the containers 3 as described above, the cloud operator lends the containers 3 included in the same Pod 4 (the containers 3 that provide the same service). For this reason, it is preferable that the cloud operator execute the above-described performance analysis for the containers 3 included in each Pod 4.

However, each piece of operation information obtainable from the physical machines 2 on which the containers 3 operate (for example, identification information of each process under execution or an instruction address of a function being executed by the process under execution) does not include information that enables the Pod 4 associated with the piece of operation information to be identified. Therefore, the cloud operator may be unable to classify pieces of information acquired from the physical machines 2 on which the containers 3 operate into information sets associated with the respective Pods 4 and therefore have no way to execute the performance analysis for each Pod 4.

To address this, the management apparatus 1 according to the present embodiment groups the multiple containers 3 into multiple groups corresponding to the respective Pods 4 based on respective generation time points of the multiple containers 3. The management apparatus 1 executes the performance analysis on the multiple containers 3 for each of the multiple groups 4, and outputs a result of the performance analysis for each of the multiple groups 4.

For example, it is possible to determine that containers 3 with the generation time points within the same time period are containers 3 included in the same Pod 4. Therefore, the management apparatus 1 forms a group of the containers 3 generated within the same time period, and further performs the performance analysis on the containers 3 allocated to each of the groups.

Thus, the management apparatus 1 is enabled to execute the performance analysis on the containers 3 included in the same Pod 4 (the containers 3 that provide the same service).

[Hardware Configuration of Information Processing System]

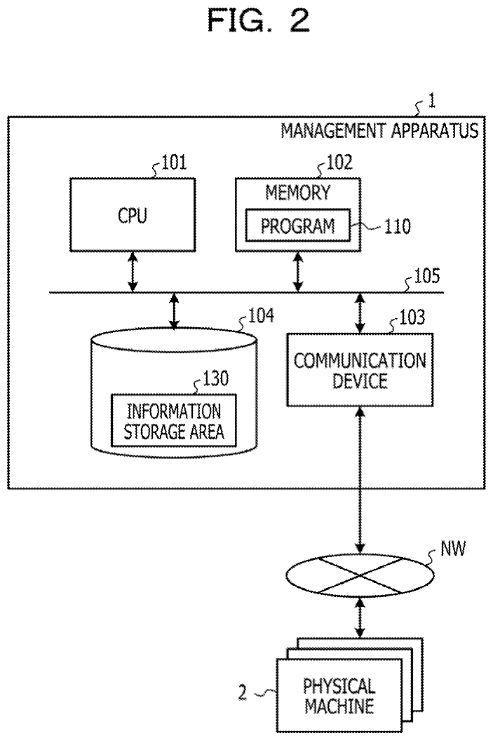

Next, a hardware configuration of the information processing system 10 will be described. FIG. 2 is a diagram for explaining a hardware configuration of the management apparatus 1.

Although a case where processing of executing the performance analysis on the containers 3 (hereinafter, also referred to as the performance analysis processing) is performed by the management apparatus 1 in the unit of the containers 3 included in each Pod 4 will be described below, the performance analysis processing may be performed for each physical machine 2. For example, the management apparatus 1 may execute the performance analysis processing on the containers 3 included in the Pod(s) 4 operating in each physical machine 2.

As illustrated in FIG. 2, the management apparatus 1 includes a central processing unit (CPU) 101 as a processor, a memory 102, a communication device 103, and a storage medium 104. These components are coupled to each other via a bus 105.

The storage medium 104 includes, for example, a program storage area (not illustrated) for storing a program 110 for executing the performance analysis processing. The storage medium 104 also includes, for example, an information storage area 130 that stores information to be used in executing the performance analysis processing. The storage medium 104 may be, for example, a hard disk drive (HDD) or a solid-state drive (SSD).

The CPU 101 executes the program 110 loaded from the storage medium 104 into the memory 102 to execute the performance analysis processing.

The communication device 103 performs communication with each of the physical machines 2 via a network NW, for example.

[Functions of Information Processing System]

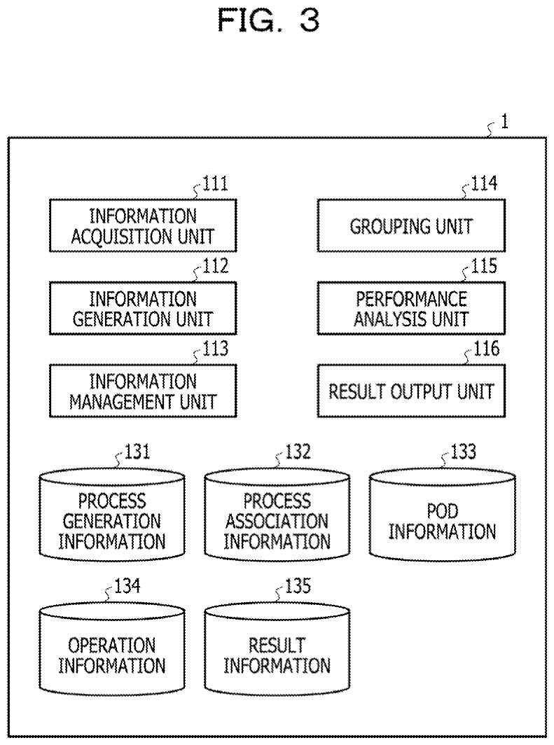

Next, functions of the information processing system 10 will be described. FIG. 3 is a block diagram of functions of the management apparatus 1.

As illustrated in FIG. 3, for example, the management apparatus 1 causes the hardware such as the CPU 101 and the memory 102 and the program 110 to organically cooperate with each other to implement various functions including an information acquisition unit 111, an information generation unit 112, an information management unit 113, a grouping unit 114, a performance analysis unit 115, and a result output unit 116.

For example, as illustrated in FIG. 3, the management apparatus 1 stores process generation information 131, process association information 132, Pod information 133, operation information 134, and result information 135 in the information storage area 130.

For example, the information acquisition unit 111 acquires information specifying generation time points of multiple processes newly generated within a predetermined time period (for example, one hour) from the operating systems (OSs) of the physical machines 2. The information generation unit 112 generates the process generation information 131 from the information acquired by the information acquisition unit 111. Thereafter, the information management unit 113 stores the process generation information 131 generated by the information generation unit 112 in the information storage area 130.

For example, from the OSs of the physical machines 2, the information acquisition unit 111 acquires information specifying a parent-child relationship of each of the multiple processes newly generated within the predetermined time period. The information generation unit 112 generates the process association information 132 from the information acquired by the information acquisition unit 111. Thereafter, the information management unit 113 stores the process association information 132 generated by the information generation unit 112 in the information storage area 130.

The information acquisition unit 111 acquires pieces of operation information 134 including identification information of processes under execution and the instruction addresses of the functions (instructions included in the functions) being executed by the processes under execution at regular timings (for example, every 1 (ms)). Then, the information management unit 113 stores the pieces of operation information 134 acquired by the information acquisition unit 111 in the information storage area 130.

With reference to the process generation information 131 and the process association information 132 stored in the information storage area 130, the grouping unit 114 sorts the containers 3 into multiple time slots by allocating each container 3 to the time slot including the generation time point of the process associated with the container 3. The grouping unit 114 groups the containers 3 into multiple groups such that one or more containers 3 allocated to the same time slot belong to the same group. For example, the grouping unit 114 groups the containers 3 such that the containers 3 presumable to be included in the same Pod 4 form a group.

Based on a result of the grouping performed by the grouping unit 114, the information generation unit 112 generates the Pod information 133 in which the process generation information 131 and the process association information 132 stored in the information storage area 130 are associated with each other. The Pod information 133 is information on the multiple processes newly generated within the predetermined time period, and includes a divided piece of information on each of the processes operating on the containers 3 included in each Pod 4. The information management unit 113 stores the Pod information 133 generated by the information generation unit 112 into the information storage area 130.

For example, the performance analysis unit 115 sorts the pieces of operation information 134 stored in the information storage area 130 into information sets associated with the respective multiple groups formed in the grouping by the grouping unit 114. For example, the performance analysis unit 115 sorts the pieces of operation information 134 stored in the information storage area 130 by forming a set of the pieces of operation information 134 associated with the processes operating in the containers 3 included in each Pod 4. For each of the multiple groups formed in the grouping by the grouping unit 114, the performance analysis unit 115 determines the ratio of the pieces of operation information 134 allocated to the group concerned.

For example, the result output unit 116 outputs the result information 135 including the ratios determined by the performance analysis unit 115. For example, the result output unit 116 outputs the result information 135 to an operation terminal (not illustrated) browsed by the cloud operator.

[Outline of First Embodiment]

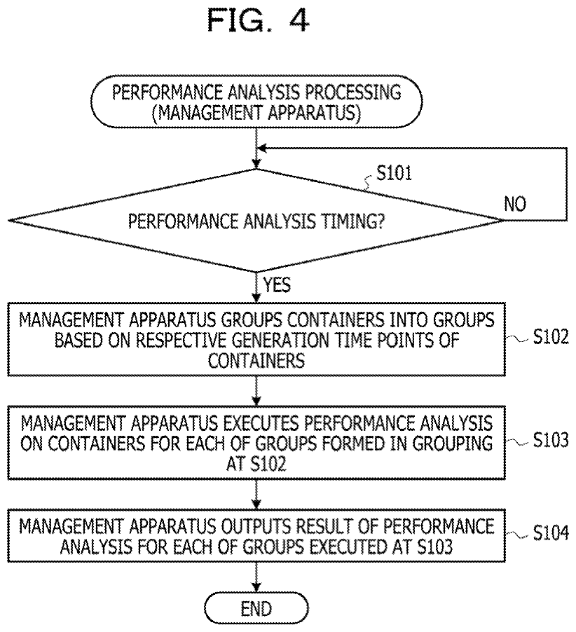

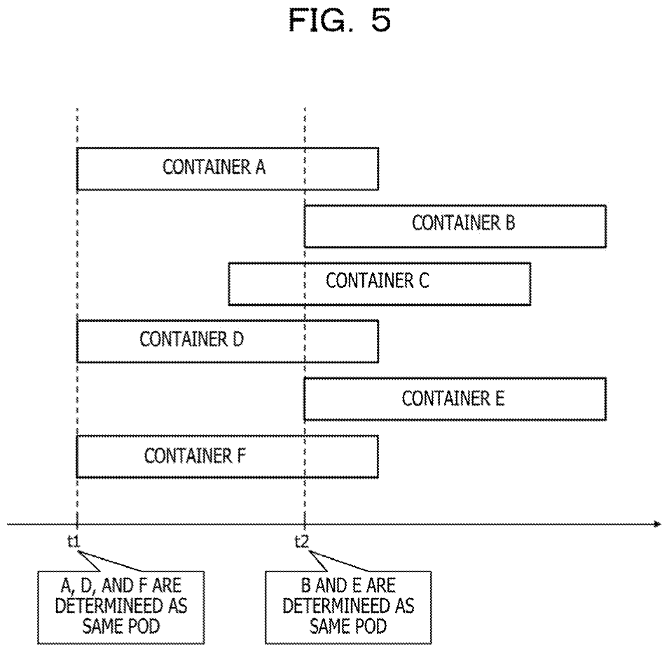

Next, an outline of a first embodiment will be described. FIG. 4 is a flowchart for explaining the outline of the performance analysis processing in the first embodiment. FIG. 5 is a diagram for explaining the outline of the performance analysis processing in the first embodiment.

The management apparatus 1 waits until a performance analysis timing arrives as illustrated in FIG. 4 (NO at S101). The performance analysis timing may be, for example, a timing at which the cloud operator inputs an Instruction to analyze the performance of the containers 3 to the management apparatus 1.

When the performance analysis timing arrives (YES at S101), the management apparatus 1 groups the multiple containers 3 into multiple groups based on the respective generation time points of the multiple containers 3 (S102).

Subsequently, the management apparatus 1 performs a performance analysis on the multiple containers 3 for each of the multiple groups formed in the grouping in the processing at S102 (S103).

After that, the management apparatus 1 outputs a result of the performance analysis performed on each of the multiple groups in the processing at S103 (S104).

For example, it is possible to determine that containers 3 with the generation time points within the same time period are containers 3 included in the same Pod 4. Therefore, the management apparatus 1 forms a group of the containers 3 generated within the same time period, and further performs the performance analysis on the containers 3 allocated to each of the groups.

For example, as illustrated in FIG. 5, when the generation time points of containers A, D, and F are the same (t1), the management apparatus 1 determines that the containers A, D, and F are containers 3 included in the same Pod 4. As illustrated in FIG. 5, for example, when the generation time points of containers B and E are the same (t2), the management apparatus 1 determines that the containers B and E are containers 3 included in the same Pod 4.

Thus, the management apparatus 1 is enabled to execute the performance analysis on the containers 3 included in the same Pod 4 (the containers 3 that provide the same service).

[Details of First Embodiment]

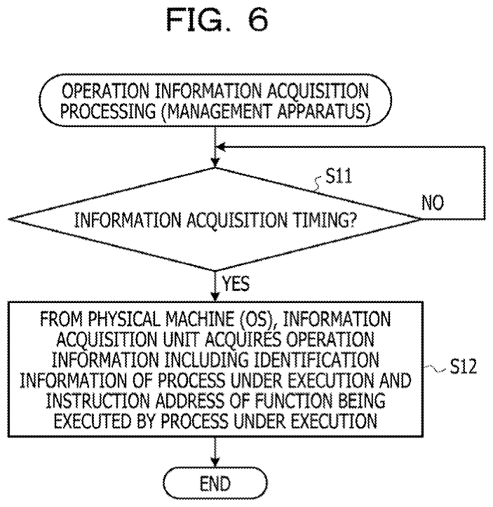

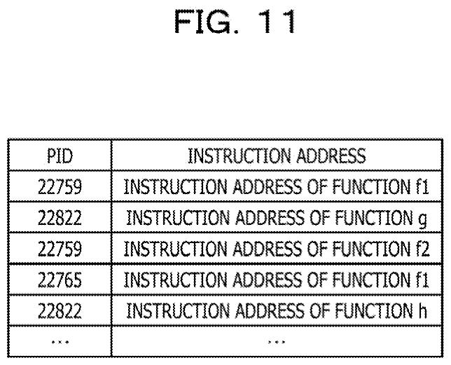

Next, details of the first embodiment will be described. FIG. 6 to are flowcharts for explaining details of the performance analysis processing in the first embodiment. FIGS. 11 to 21 are diagrams for explaining the details of the performance analysis processing in the first embodiment.

[Operation Information Acquisition Processing]

First, description will be given of processing of acquiring the operation information 134 (hereinafter, also referred to as operation information acquisition processing) in the performance analysis processing. FIG. 6 is the flowchart for explaining the operation Information acquisition processing.

As illustrated in FIG. 6, the information acquisition unit 111 of the management apparatus 1 waits until an information acquisition timing arrives (NO at S11). The information acquisition timing may be, for example, a timing at which the cloud operator inputs an instruction to acquire the operation information 134 from each physical machine 2 to the management apparatus 1.

When the information acquisition timing arrives (YES at S11), the information acquisition unit 111 acquires, from the OS of each physical machine 2, the operation information 134 including the identification information of processes under execution and the instruction addresses of the functions being executed by the processes under execution (S12).

For example, the OS of each physical machine 2 acquires the operation information 134 on the processes currently being executed in the physical machine 2 at predetermined time intervals (for example, every 1 (ms)) in response to a counter overflow interrupt of a performance monitoring counter (PMC) register included in the CPU (not illustrated) of the physical machine 2. When the information acquisition timing arrives, the information acquisition unit 111 acquires, for example, all the operation information 134 acquired after the previous information acquisition timing from the OS of each physical machine 2. Specific examples of the operation information 134 will be described below.

[Specific Example of Operation Information]

FIGS. 11, 15, 16, and 18 to 20 are diagrams for explaining specific examples of the operation information 134. For example, FIG. 11 is a diagram for explaining a specific example of the operation information 134 accumulated in the information storage area 130.

The operation information 134 illustrated in FIG. 11 and so on contains, as items, a “PID” specifying identification information of each process under execution and an “instruction address” specifying an instruction address of a function (an instruction included in the function) being executed by the process under execution.

For example, in the operation information 134 illustrated in FIG. 11, the information in the first line contains “22759” set as the “PID” and the “instruction address of a function f1” set as the “instruction address”.

In the operation information 134 illustrated in FIG. 11, the information in the second line contains “22822” set as the “PID” and the “instruction address of a function g” set as the “instruction address”. Description of the other information included in FIG. 11 is omitted herein.

[Main Processing of Performance Analysis Processing]

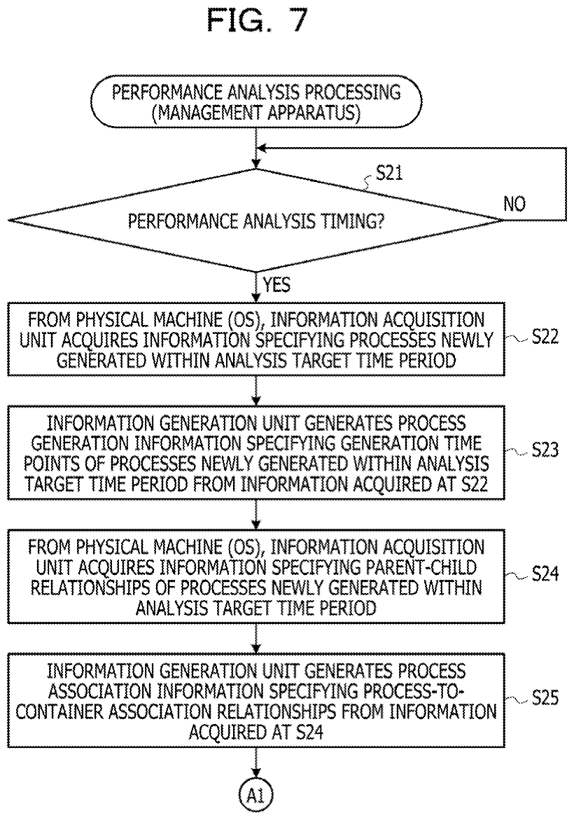

Next, main processing of the performance analysis processing will be described. FIGS. 7 to 10 are the flowcharts for explaining the main processing of the performance analysis processing.

As illustrated in FIG. 7, the information acquisition unit 111 waits until a performance analysis timing arrives (NO at S21). The performance analysis timing may be, for example, a timing which arrives when a predetermined analysis target time period elapses.

When the performance analysis timing arrives (YES at S21), the information acquisition unit 111 acquires, from the OS of each physical machine 2, information specifying multiple processes newly generated within the analysis target time period, for example (S22).

For example, the OS of the physical machine 2 acquires, in advance, information specifying processes operating in the physical machine 2 at a stage immediately before the analysis target time period starts (hereinafter, also referred to as initial process information). For example, the OS of the physical machine 2 periodically acquires information specifying processes currently being operating in the physical machine 2 (hereinafter, also referred to as current process information) until the analysis target time period elapses.

Thereafter, when the performance analysis timing arrives, the information acquisition unit 111 acquires the initial process information and the current process information (the latest current process Information) from the OS of the physical machine 2 and compares the initial process information and the current process information thus acquired. The information acquisition unit 111 identifies processes included in the processes specified in the current process information but not included in the processes specified in the initial process information, and determines the information specifying the identified processes as the information specifying the multiple processes newly generated within the analysis target time period.

Here, the OS of the physical machine 2 may use, for example, a function of detecting generation of every new process (hook function) to detect processes newly generated within the analysis target time period. In this case, for example, when the performance analysis timing arrives, the information acquisition unit 111 may determine the information specifying the processes detected within the analysis target time period by the OS of the physical machine 2 as the information specifying the processes newly generated within the analysis target time period.

Referring back to FIG. 7, the information generation unit 112 of the management apparatus 1 generates, from the information acquired in the processing at S22, the process generation information 131 specifying the generation time points of the multiple processes newly generated within the analysis target time period (S23). A specific example of the process generation information 131 will be described below.

[Specific Example of Process Generation Information]

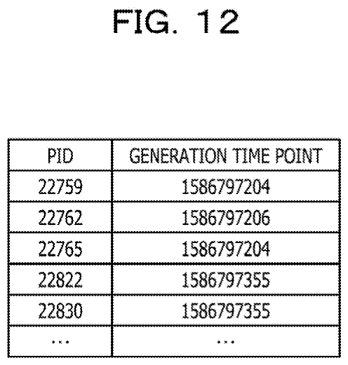

FIG. 12 is a diagram for explaining a specific example of the process generation information 131.

The process generation information 131 illustrated in FIG. 12 contains, as items, a “PID” specifying identification information of each process newly generated within the analysis target time period, and a “generation time point” specifying the generation time point of each process.

For example, in the process generation information 131 illustrated in FIG. 12, the information in the first line contains “22759” set as the “PID” and “1586797204” set as the “generation time point”.

In the process generation information 131 illustrated in FIG. 12, the information in the second line contains “22762” set as the “PID” and “1586797206” set as the “generation time point”. Description of the other information included in FIG. 12 is omitted herein.

Referring back to FIG. 7, the information acquisition unit 111 acquires, from the OS of the physical machine 2, information specifying a parent-child relationship of each of the processes newly generated within the analysis target time period (S24).

For example, the information acquisition unit 111 acquires, from the OS of the physical machine 2, information specifying a parent process of each process newly generated within the analysis target time period.

Then, the information generation unit 112 generates the process association information 132 specifying process-to-container association relationships from the information acquired in the processing at S24 (S25).

For example, the information generation unit 112 determines, from the information acquired in the processing at S24, whether each of the processes newly generated within the analysis target time period has a parent-child relationship with a process that manages any of the containers 3. For example, the information generation unit 112 determines that a process having a parent-child relationship with a process that manages any of the containers 3 among the processes newly generated within the analysis target time period is a process that operates in the container 3 (hereinafter, also referred to as the container process). Thereafter, the information generation unit 112 generates information specifying the container process(es) associated with each container 3 as the process association information 132. A specific example of the process association information 132 will be described below.

[Specific Example of Process Association Information]

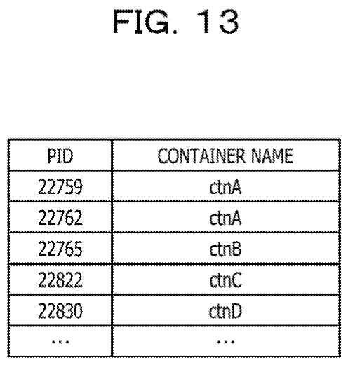

FIG. 13 is a diagram for explaining a specific example of the process association information 132.

The process association information 132 illustrated in FIG. 13 contains, as items, a “PID” specifying identification information of each process (container process) newly generated within the analysis target time period, and a “container name” specifying the name of the container 3 associated with each process.

For example, in the process association Information 132 illustrated in FIG. 13, the information in the first line contains “22759” set as the “PID” and “ctnA” set as the “container name”.

In the process association information 132 illustrated in FIG. 13, the information in the second line contains “22762” set as the “PID” and “ctnA” set as the “container name”. Description of the other Information included in FIG. 13 is omitted herein.

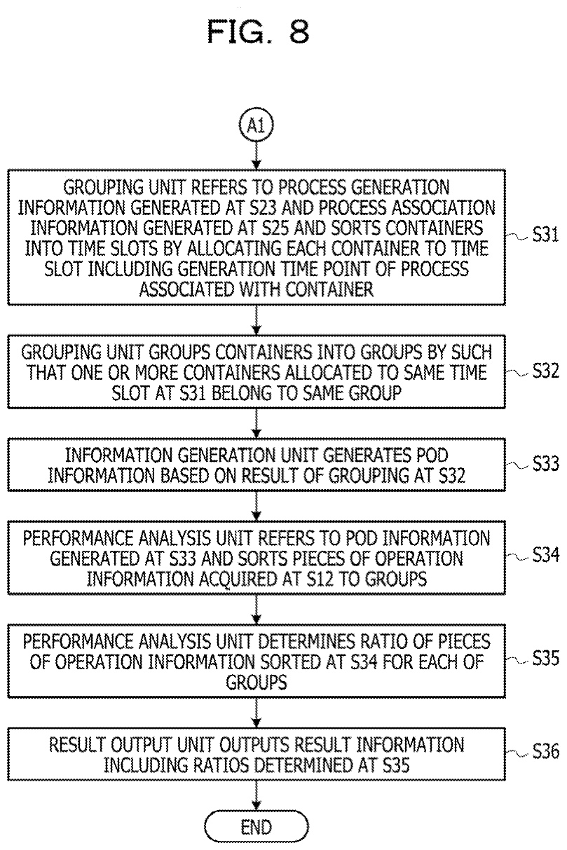

Referring back to FIG. 8, the grouping unit 114 of the management apparatus 1 refers to the process generation information 131 generated in the processing at S23 and the process association information 132 generated in the processing at S25, and thereby sorts the containers 3 into time slots by allocating each container 3 to the time slot including the generation time point of the process associated with the container 3 (S31).

The grouping unit 114 groups the containers 3 into multiple groups such that one or more containers 3 allocated to the same time slot in the processing at S31 belong to the same group (S32).

After that, the Information generation unit 112 generates the Pod information 133 based on the result of the grouping in the processing at S32 (S33). Details of the processing at S31 to S33 will be described below.

[Details of Processing at 931 to S33]

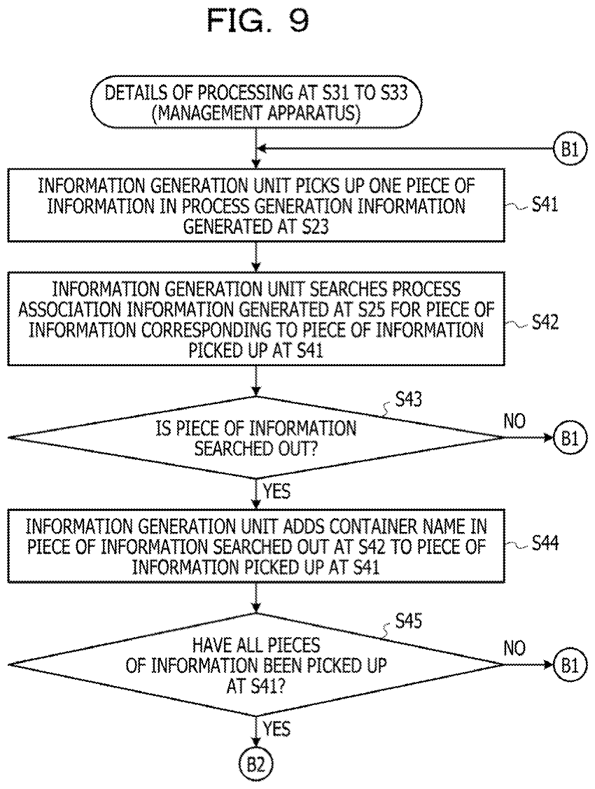

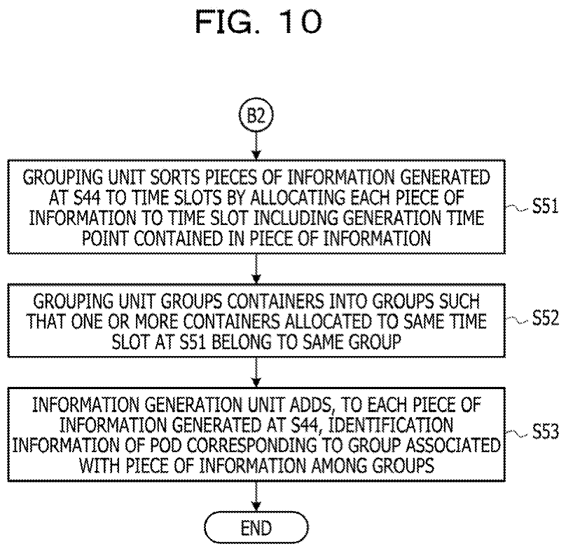

FIGS. 9 and 10 are the flowchart for explaining the details of the processing at S31 to S33.

As illustrated in FIG. 9, the information generation unit 112 picks up one piece of information included in the process generation information 131 generated in the processing at S23 (S41).

The information generation unit 112 searches the process association information 132 generated in the processing at S25 for a piece of information corresponding to the piece of information picked up in the processing at S41 (S42).

For example, in the processing at S41, the information generation unit 112 picks up the piece of information containing the “PID” of “22759” (the information in the first line) in the process generation information 131 illustrated in FIG. 12. In the processing at S42, for example, the information generation unit 112 searches the process association information 132 illustrated in FIG. 13 for the piece of information (the information in the first line) in which the information set as the “PID” is the same as the piece of information picked up in the processing at S41.

Subsequently, the information generation unit 112 determines whether or not the piece of information corresponding to the piece of information picked up in the processing at S41 is searched out in the processing at S42 (S43).

As a result, if it is determined that the piece of information corresponding to the piece of information picked up in the processing at S41 is not searched out in the processing at S42 (NO at S43), the Information generation unit 112 performs the processing at S41 and the subsequent steps again.

On the other hand, if it is determined that the piece of information corresponding to the piece of information picked up in the processing at S41 is searched out in the processing at S42 (YES at S43), the Information generation unit 112 adds the container name included in the piece of information searched out in the processing at S42 to the piece of information picked up in the processing at S41 (S44).

For example, the information in the first line in the process association information 132 described with reference to FIG. 13 contains “ctnA” set as the “container name”. Thus, for example, when the information in the first line of the process generation information 131 illustrated in FIG. 12 is picked up in the processing at S41 and the information in the first line of the process association information 132 illustrated in FIG. 13 is searched out in the processing at S42, the information generation unit 112 adds information specifying that the “container name” is “ctnA” to the information in the first line of the process generation information 131 illustrated in FIG. 12 in the processing at S44.

After that, the information generation unit 112 determines whether all the pieces of information included in the process generation information 131 generated in the processing at S23 have been picked up in the processing at S41 (S45).

As a result, when it is determined that all the pieces of information included in the process generation information 131 generated in the processing at S23 have not been picked up in the processing at S41 (NO at S45), the information generation unit 112 performs the processing at S41 and the subsequent steps again.

On the other hand, when it is determined that all the pieces of information included in the process generation information 131 generated in the processing at S23 have been picked up in the processing at S41 (YES at S45), the grouping unit 114 sorts the pieces of information generated in the processing at S44 into multiple time slots by allocating each piece of the information to the time slot including the generation time point contained in the piece of the information (S51) as illustrated in FIG. 10.

The grouping unit 114 groups the containers 3 into multiple groups such that one or more containers 3 allocated to the same time slot in the processing at S51 belong to the same group (552).

For example, in the process generation information 131 described with reference to FIG. 12, the pieces of information containing “22759”, “22762”, and “22765” set as the “PID” (the information in the first, second, and third lines) contain “1586797204”, “1586797206”, and “1586797204” set as the “generation time point”, respectively. Then, “cnA”, “cnA”, and “cnB” are added as the “container name” to the pieces of information containing “22759”, “22762”, and “22765” set as the “PID” (the information in the first, second, and third lines), respectively, in the process generation information 131 described with reference to FIG. 12.

In this situation, for example, when “1586797204” and “1586797206” are determined to be included in the same time slot, the information generation unit 112 groups the container 3 with the “container name” of “ctnA” and the container 3 with the “container name” of “ctnB” into the same group.

For example, in this case, the information generation unit 112 determines that the container 3 with the “container name” of “ctnA” and the container 3 with the “container name” of “ctnB” are included in the same Pod 4.

In the processing at S32, for example, the information generation unit 112 may perform the grouping of the containers 3 by determining that multiple generation time points with a time difference of less than 10 seconds are multiple generation time points included in the same time slot.

After that, the information generation unit 112 generates the Pod information 133 by adding, to each of the pieces of information generated in the processing at S44, the identification information (hereinafter, also referred to as an ID) of the Pod 4 corresponding to the group associated with the piece of Information among the multiple groups (S53). A specific example of the Pod information 133 generated in the processing at S53 will be described below.

[Specific Example of Pod Information]

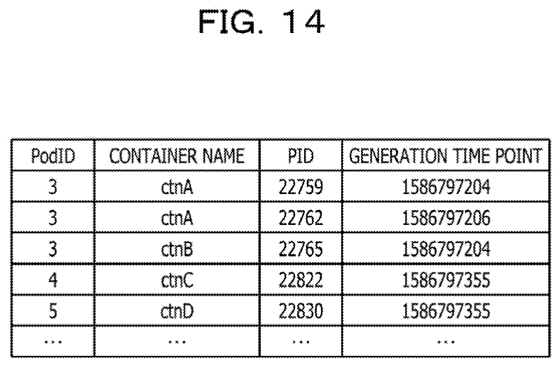

FIG. 14 is a diagram for explaining a specific example of the Pod information 133.

The Pod information 133 illustrated in FIG. 14 contains as items, for example, a “PID” specifying identification information of each process (container process) newly generated within the analysis target time period, a “container name” specifying the name of the container 3 associated with each process, and a “generation time point” specifying the generation time point of each process. The Pod information 133 illustrated in FIG. 14 also contains, as an item, a “PodID” specifying the ID of the Pod 4 including each container 3.

For example, the information in the first line in FIG. 14 is information in which the information in the first line of the process generation information 131 described with reference to FIG. 12 and the information in the first line of the process association information 132 described with reference to FIG. 13 are combined together. The Information in the second line in FIG. 14 is information in which the information in the second line of the process generation information 131 described with reference to FIG. 12 and the information in the second line of the process association information 132 described with reference to FIG. 13 are combined together. Therefore, when “1586797204” and “1586797206” set in the first and second lines of the “generation time point” in FIG. 14 are determined to be included in the same time slot, the information generation unit 112 sets “3”, which is the ID of the same Pod 4, in both of the “PodID” of the information in the first line and the “PodID” of the information in the second line, for example, as illustrated in FIG. 14. Description of the other information included in FIG. 14 is omitted herein.

Referring back to FIG. 8, the performance analysis unit 115 of the management apparatus 1 refers to the Pod information 133 generated in the processing at S33, and thereby sorts the pieces of the operation Information 134 acquired in the processing at S12 to the multiple groups formed in the grouping by the processing at S32 (S34).

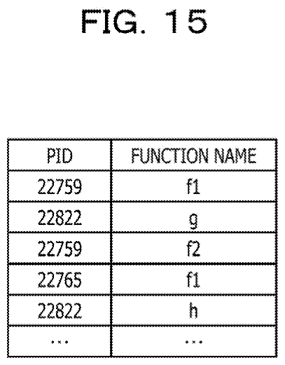

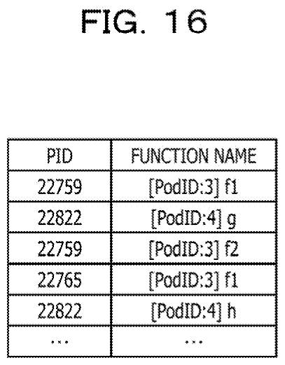

For example, as illustrated in operation information 134a in FIG. 15, the performance analysis unit 115 sets, in a “function name”, a symbol name (function name) identified by performing symbol resolution on the information set as the “instruction address” in the operation information 134 described with reference to FIG. 11. As illustrated in operation Information 134b in FIG. 16, the performance analysis unit 115 adds Information specifying the ID of the Pod 4 including the container 3 associated with the process set in the “PID” to the information already set in the “function name”, for example.

The performance analysis unit 115 determines the ratio of the pieces of the operation information 134 allocated in the processing at S34 to each of the multiple groups formed in the grouping by the processing at S32 (S35). After that, the performance analysis unit 115 generates result information 135 including the ratios of the pieces of the operation information 134 sorted in the processing at S34. A specific example of the result information 135 will be described below.

[Specific Example of Result Information (1)]

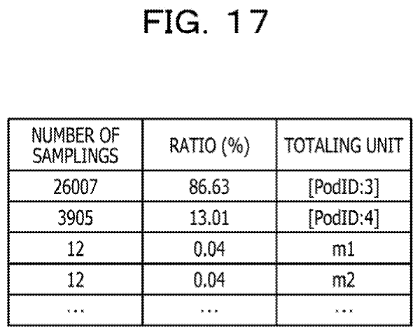

FIG. 17 is a diagram for explaining a specific example of the result information 135.

The result information 135 illustrated in FIG. 17 contains, as items, a “totaling unit” specifying a unit for calculating totals for the pieces of the operation information 134 acquired in the processing at S12, a “number of samplings” specifying the number of the pieces of the operation information 134 falling under each totaling unit among all the pieces of the operation information 134, and a “ratio” specifying a ratio of the pieces of the operation information 134 falling under each totaling unit to all the pieces of the operation information 134.

In the example illustrated in FIG. 17, for example, the ID of the Pod 4 corresponding to each of the multiple groups formed in the grouping by the processing at S32 is set as the “totaling unit”. In the example illustrated in FIG. 17, for example, the function name of a function included in a process (a process other than the container process) that is not included in any of the multiple groups formed in the grouping by the processing at S32 is set as the “totaling unit”.

For example, in the result Information 135 illustrated in FIG. 17, the information in the first line contains “26007” set as the “number of samplings”, “86.63(%)” set as the “ratio”, and “[PodID: 3]” specifying the ID of the Pod 4 set as the “totaling unit”.

In the result information 135 illustrated in FIG. 17, the information in the second line contains “3905” set as the “number of samplings”, “13.01(%)” set as the “ratio”, and “[PodID: 4]” specifying the ID of the Pod 4 set as the “totaling unit”.

In the result information 135 illustrated in FIG. 17, the information in the third line contains “12” set as the “number of samplings”, “0.04(%)” set as the “ratio”, and “m1” specifying the function name set as the “totaling unit”. Description of the other information included in FIG. 17 is omitted herein.

Referring back to FIG. 8, the result output unit 116 of the management apparatus 1 outputs the result information 135 including the ratios determined in the processing at S35 (S36). For example, the result output unit 116 outputs the result information 135 to an operation terminal (not illustrated) browsed by the cloud operator.

As described above, the management apparatus 1 according to the present embodiment groups multiple containers 3 into multiple groups corresponding to multiple Pods 4 based on the respective generation time points of the multiple containers 3. The management apparatus 1 executes the performance analysis on the multiple containers 3 for each of the multiple groups 4, and outputs a result of the performance analysis for each of the multiple groups 4.

For example, it is possible to determine that containers 3 with the generation time points within the same time period are containers 3 included in the same Pod 4. Therefore, the management apparatus 1 forms a group of the containers 3 generated within the same time period, and further performs the performance analysis on the containers 3 allocated to each of the groups.

Thus, the management apparatus 1 is enabled to execute the performance analysis on the containers 3 included in the same Pod 4 (the containers 3 that provide the same service).

In the processing at S34, the pieces of the operation information 134 acquired in the processing at S12 by the performance analysis unit 115 may be sorted into the containers 3 for each of the multiple groups formed in the grouping by the processing at S32.

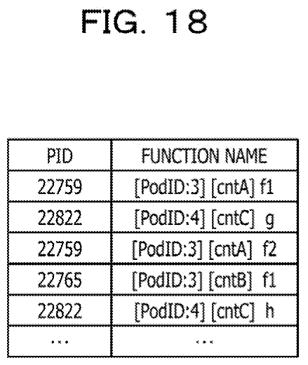

For example, as in operation information 134c illustrated in FIG. 18, the performance analysis unit 115 adds the container name of a container 3 associated with each process set in the “PID” and the ID of the Pod 4 including the container 3 to the “function name”.

For example, from among the pieces of the operation information 134 acquired in the processing at S12, the performance analysis unit 115 picks up pieces of the operation information 134 associated with a certain group (hereinafter, also referred to as an analysis target group) in the multiple groups formed in the grouping by the processing at S32. The performance analysis unit 115 performs padding for the pieces of the operation information 134 not associated with the analysis target group among the pieces of the operation information 134 acquired in the processing at S12.

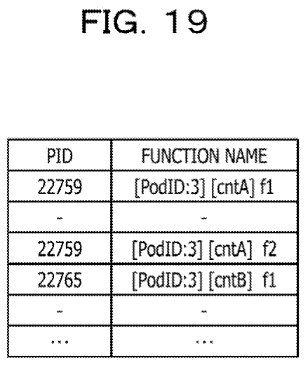

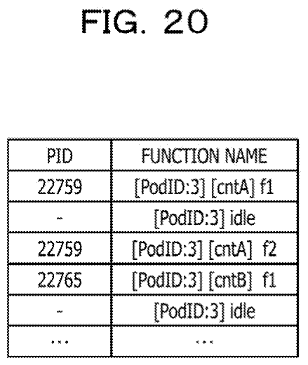

For example, as illustrated in FIG. 19, the performance analysis unit 115 generates operation information 134d by picking up only the pieces of the operation information 134c associated with the Pod 4 having the “ID” of “3” which is the analysis target group from among the pieces of the operation information 134c illustrated in FIG. 18. As illustrated in FIG. 20, the performance analysis unit 115 generates operation information 134e by performing padding to cells of the operation information 134d illustrated in FIG. 19 in which the pieces of the operation information 134d associated with the analysis target group are not set.

After that, in the processing at S35, for example, for each of the containers 3 included in the analysis target group, the performance analysis unit 115 determines the ratio of the pieces of the operation information 134 associated with the container 3 based on the padded operation information 134.

For example, for each of the containers 3 included in the analysis target group, the performance analysis unit 115 determines the ratio of the pieces of the operation information 134e associated with the container 3 to all the pieces of the operation information 134e. A specific example of the result information 135 in the case where the pieces of the operation information 134 acquired in the processing at S12 are sorted into the containers 3 included in the analysis target group will be described below.

[Specific Example of Result Information (2)]

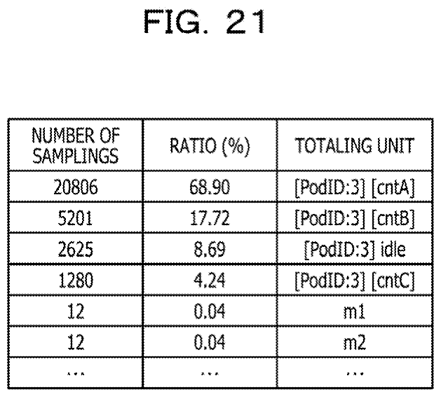

FIG. 21 is a diagram for explaining a specific example of the result information 135. FIG. 21 illustrates a specific example of the result information 135 in the case where the “ID” of the Pod 4 corresponding to the analysis target group is “3”.

The result information 135 illustrated in FIG. 21 contains the same items as those of the result information 135 described with reference to FIG. 17.

For example, in the result information 135 illustrated in FIG. 21, the information in the first line contains “20806” set as the “number of samplings”, “68.90(%)” set as the “ratio”, and “[PodID: 3] [ctnA]” specifying the ID of the Pod 4 and the container name of the container 3 set as the “totaling unit”. For example, this means that the information in the first line in FIG. 21 is information specifying the totaling result for the pieces of the operation information 134 associated with the container 3 having the “container name” of “ctnA” among the containers 3 included in the analysis target group.

In the result information 135 illustrated in FIG. 21, for example, the information in the second line contains “5201” set as the “number of samplings”, “17.73(%)” set as the “ratio”, and “[PodID: 3] [ctnB]” specifying the ID of the Pod 4 and the container name of the container 3 set as the “totaling unit”. For example, this means that the information in the second line in FIG. 21 is information specifying the totaling result for the pieces of the operation information 134 associated with the container 3 having the “container name” of “ctnB” among the containers 3 included in the analysis target group.

In the result information 135 illustrated in FIG. 21, for example, the information in the third line contains “2625” set as the “number of samplings”, “8.69(%)” set as the “ratio”, and “[PodID: 3] idle” set as the “totaling unit”. For example, the information in the third line in FIG. 21 is information specifying the totaling result for the pieces of the operation information 134 associated with all the groups except for the analysis target group, and is the information specifying the totaling result in a case where an idle function is applied in a pseudo manner for the purpose of specifying the ratio corresponding to the time slot in which the analysis target group is in the idle state.

In the result information 135 illustrated in FIG. 21, for example, the information in the fifth line contains “12” set as the “number of samplings”, “0.04(%)” set as the “ratio”, and “m1” specifying the function name set as the “totaling unit”. Description of the other information included in FIG. 21 is omitted herein.

Thus, the management apparatus 1 is enabled to execute the performance analysis on each of the containers 3 included in the analysis target group.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A performance analysis method of causing a computer to execute a process, the process comprising:
grouping a plurality of containers into a plurality of groups based on respective generation time points of the plurality of containers;
executing performance analysis on the plurality of containers for each of the plurality of groups; and
outputting a result of the performance analysis for each of the plurality of groups.

2. The performance analysis method according to claim 1, wherein
the grouping includes
sorting the plurality of containers to a plurality of time slots by allocating each of the containers to the time slot including the generation time point of the container; and
grouping the plurality of containers such that one or more of the containers allocated to the same time slot among the plurality of time slots belong to the same group.

3. The performance analysis method according to claim 2, causing the computer to execute the process further comprising
acquiring process generation information specifying the generation time points of a plurality of processes newly generated within a predetermined time period and process association information specifying a container associated with each of the plurality of newly generated processes among the plurality of containers, wherein
the grouping includes referring to the process generation information and the process association information to sort the plurality of containers into the plurality of time slots by allocating each of the containers to the time slot including the generation time point of the process associated with the container.

4. The performance analysis method according to claim 1, causing the computer to execute the process further comprising
acquiring operation information including identification information of each process under execution and an instruction address of a function being executed by the process, wherein
the executing the performance analysis includes generating information specifying a running time for each of the plurality of groups with reference to the operation information.

5. The performance analysis method according to claim 4, wherein
the acquiring the operation information includes acquiring the operation information at a plurality of timings, and
the executing the performance analysis includes
sorting pieces of the operation information acquired at the plurality of timings to the plurality of groups by allocating each piece of the operation information to the group associated with the piece of operation information, and
generating, as the information specifying the running time for each of the plurality of groups, information including a ratio of the pieces of the operation information allocated to the group.

6. The performance analysis method according to claim 4, wherein
the executing the performance analysis includes generating information specifying a running time of each container included in any group among the plurality of groups with reference to the operation information.

7. A non-transitory computer-readable recording medium storing a performance analysis program causing a computer to execute a process, the process comprising:
grouping a plurality of containers into a plurality of groups based on respective generation time points of the plurality of containers;
executing performance analysis on the plurality of containers for each of the plurality of groups; and
outputting a result of the performance analysis for each of the plurality of groups.

8. The non-transitory computer-readable recording medium according to claim 7, wherein
the grouping includes
sorting the plurality of containers to a plurality of time slots by allocating each of the containers to the time slot including the generation time point of the container; and
grouping the plurality of containers such that one or more of the containers allocated to the same time slot among the plurality of time slots belong to the same group.

9. The non-transitory computer-readable recording medium according to claim 8, further comprising:
acquiring process generation information specifying the generation time points of a plurality of processes newly generated within a predetermined time period and process association information specifying a container associated with each of the plurality of newly generated processes among the plurality of containers, wherein
the grouping includes referring to the process generation information and the process association information to sort the plurality of containers into the plurality of time slots by allocating each of the containers to the time slot including the generation time point of the process associated with the container.

10. The non-transitory computer-readable recording medium according to claim 7, further comprising:
acquiring operation information including identification information of each process under execution and an instruction address of a function being executed by the process, wherein
the executing the performance analysis includes generating information specifying a running time for each of the plurality of groups with reference to the operation information.

11. The non-transitory computer-readable recording medium according to claim 10, wherein
the acquiring the operation Information includes acquiring the operation information at a plurality of timings, and
the executing the performance analysis includes
sorting pieces of the operation information acquired at the plurality of timings to the plurality of groups by allocating each piece of the operation information to the group associated with the piece of operation information, and
generating, as the information specifying the running time for each of the plurality of groups, information including a ratio of the pieces of the operation information allocated to the group.

12. The non-transitory computer-readable recording medium according to claim 10, wherein
the executing the performance analysis Includes generating information specifying a running time of each container included in any group among the plurality of groups with reference to the operation information.
